(19) United States
(12) Patent Application Publication
(10) Pub. No.: US 2026/0047698 A1
(43) Pub. Date: Feb. 19, 2026

(54) Unscanned Item Handling In Self-Scanning Systems

(71) Applicant: ZEBRA TECHNOLOGIES CORPORATION, Lincolnshire, IL (US)

(72) Inventors: Raghavendra Tenkasi Shankar, New York, NY (US); Abhilash Gururaja, Levittown, NY (US); Zhijia Yuan, Bethel Park, PA (US)

(21) Appl. No.: 18/803,157

(22) Filed: Aug. 13, 2024

(51) Int. Cl. A47F 10/02; G07G 1/00; G07G 1/01

(52) U.S. Cl. CPC A47F 10/02; G07G 1/0036; G07G 1/01

(57) ABSTRACT

A method in a computing device includes: detecting an unscanned item within the cart from an image of an interior of the cart; in response to detecting the unscanned item, determining a location of the unscanned item within the cart; generating anomaly data having the location of the unscanned item within the cart; and causing a display of the anomaly data.

### BACKGROUND

Retail facilities may implement self-scanning systems, in which customers use computing devices, e.g., from a pool of such devices deployed by the operator of the facility, to identify items as the items are retrieved from shelves. The computing devices may be mounted on shopping carts into which the items are placed. An item that a computing device do not successfully identify upon placement of the item into the cart may become difficult to locate and identify later.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a system for self-scanning.

FIG. 2 is a flowchart of a method of handling unscanned items.

FIG. 3 is a diagram illustrating an example performance of blocks 205 and 210 of the method of FIG. 2.

FIG. 4 is a diagram illustrating an example performance of blocks 205 to 215 of the method of FIG. 2.

FIG. 5 is a diagram illustrating an example message presented following a negative determination at block 240 of the method of FIG. 2.

FIG. 6 is a diagram illustrating an example performance of block 245 of the method of FIG. 2.

FIG. 7 is a diagram illustrating another example performance of block 245 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device includes: detecting an unscanned item within the cart from an image of an interior of the cart; in response to detecting the unscanned item, determining a location of the unscanned item within the cart; generating anomaly data having the location of the unscanned item within the cart; and causing a display of the anomaly data.

Additional examples disclosed herein are directed to a computing device, comprising: a processor configured to: detect an unscanned item within the cart from an image of an interior of the cart; in response to detecting the unscanned item, determine a location of the unscanned item within the cart; generate anomaly data having the location of the unscanned item within the cart; and cause a display of the anomaly data.

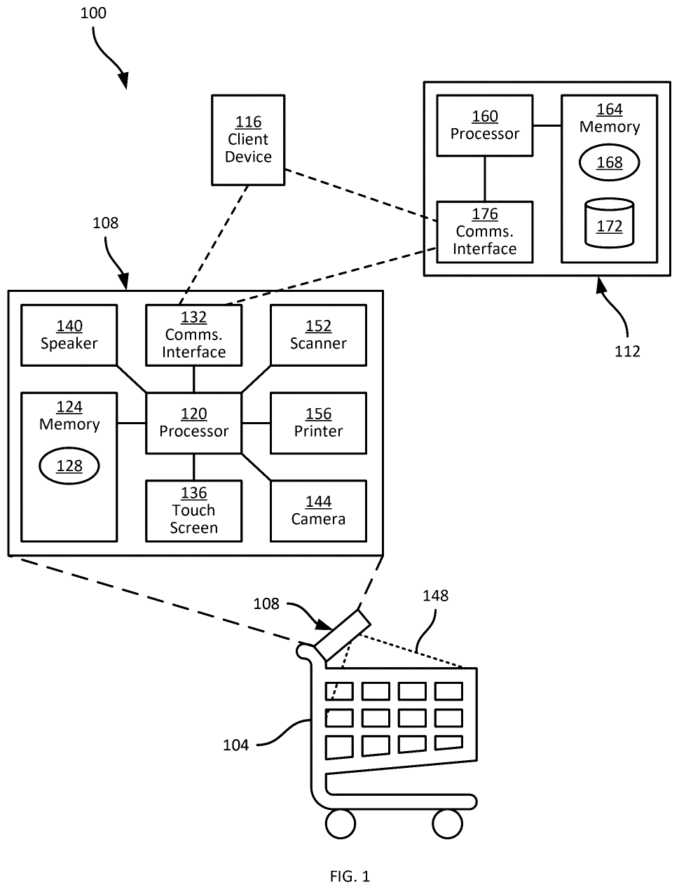

FIG. 1 illustrates a system 100 for self-scanning and/or self-checkout, e.g., in a retail facility such as a grocer or the like. The facility can include a plurality of aisles or other suitable regions, each containing a variety of items (e.g., dry goods, produce, and/or any of a wide variety of other placed on shelves, pegboards, or other support structures. As a customer moves through the aisles, the customer can retrieve items from the shelves and place the items in a receptacle such as a shopping cart 104.

The cart 104 can be provided with a computing device 108 configured to provide self-scanning functionality. For example, the device 108 can removably mounted to the cart 104, or integrated with the cart 104. In other examples, the device 108 need not be physically associated with the cart 104. For example, the device 108 can be a handheld device manipulated by the customer independently from the cart 104. In further examples, the device 108 can be a fixed device deployed in the facility (e.g., one of a plurality of devices disposed throughout the facility). The device 108 includes one or more sensors configured to capture images or other data representing items placed in the cart 104. Based on such data (e.g., barcodes captured and decoded by the device 108 from images of the items, laser scans of the items, or the like), the device 108 can store identifiers such as stock-keeping unit (SKU) identifiers, universal product codes (UPC), or the like.

The facility can include a plurality of carts 104 equipped with devices 108, and/or a plurality of carts and a plurality of devices 108 that can be retrieved and mounted to the carts, e.g., near an entrance of the facility. Thus, as the customer traverses the facility selecting and placing items in the cart 104, the device 108 can construct a list of item identifiers corresponding to the contents of the cart 104. The device 108 can also, in some implementations, be configured to retrieve price and/or other information for the items placed in the cart 104, e.g., from local memory at the device 108 or from a server 112 via one or more communication networks (e.g., a local area network deployed in the facility). Based on the price information, the device 108 can be configured to implement a transaction process to obtain payment from the customer (e.g., to implement a self-checkout procedure).

The device 108 can be configured to identify items placed in the cart 104 according to various processes. In some examples, item identification can involve holding an item (e.g., by the customer) in the field of view of a barcode scanner, camera, or the like of the device 108, permitting the device 108 to capture an identifier appearing on the item, e.g., in the form of a barcode. The device 108 can, in response to capturing the identifier, generate an audible tone or other perceptible output indicating that the item was successfully identified, whereupon the customer can place the item in the cart 104. In other examples, an explicit scanning step as outlined above may be omitted, and the customer can instead place items in the cart 104 without first holding the items in a designated scanning volume adjacent to the device 108. In such implementations, the device 108 can be configured to periodically capture images, barcode scans, or the like, of an interior of the cart 104 and detect items therein.

In either of the above implementations, one or more items may be placed in the cart 104 without being successfully identified by the device 108. For example, a customer may retrieve and place several items into the cart 104 and forget to scan one of the items. In another example, an automatic item identification process implemented by the device 108 (e.g., that does not require explicit scanning) may be unable to identify the item because the item is obscured by other items. Items in the cart 104 for which the device 108 does not obtain identifiers via scan operations or automatic identification as set out above are referred to as unscanned items.

As will be apparent from the discussion above, an unscanned item is not added to a list of items representing the contents of the cart 104, and is therefore not included in a transaction initiated based on the list. Unscanned items may, in other words, be removed from the facility without payment.

Even when the device 108 can detect an unscanned item, exception handling for the unscanned items can take various forms, at least some of which may result in suboptimal results for the facility operator, the customer, and/or staff of the facility. For example, in some systems the device 108 can be configured to respond to detection of an unscanned item by halting the self-scanning process until a staff member of the facility attends to identify the unscanned item, or until the customer retrieves the unscanned item for identification. Such systems may lead to lengthy interruptions, e.g., depending on the level of staffing available at the facility, difficulty in locating an item by the customer, or the like.

Other systems may handle the potential presence of unscanned items by implementing an audit process, e.g., by which one or more staff members compare the contents of customers' carts 104 to receipts or other itemization data at an exit of the facility. The self-scanning process in such systems therefore need not be interrupted. Auditing carts 104 in this manner, however, can be time-consuming and may represent a suboptimal use of staff time, given that many audited carts 104 will not contain unscanned items.

Avoiding both interruptions to the self-scanning process and potentially time-consuming audits presents a technical challenge, in that although the device 108 can detect an unscanned item at the time the unscanned item is placed into the cart 104, the unscanned item may subsequently be obscured by other items, and detection of the unscanned item later may be difficult. In other words, avoiding interruptions to the self-scanning process may involve omitting action by the device 108 at the time an unscanned item is detected, but the device 108 may be unable to detect the unscanned item at a later time.

To resolve the potentially conflicting factors set out above, the device 108 is configured, as discussed below, to generate and store various forms of anomaly data in response to detecting an unscanned item. The anomaly data can be stored locally at the device 108 and/or transmitted to the server 112. The device 108 and/or the server 112 can be configured to provide such anomaly data to a client device 116, e.g., operated by a staff member in the facility, to accelerate an audit of the cart 104 by providing visual guidance as to the location of the unscanned item within the cart 104.

Certain internal components of the device 108, and the server 112, are also shown in FIG. 1. For example, the device 108 can include a processor 120, such as a central processing unit (CPU), graphics processing unit (GPU), or the like, communicatively coupled with a non-transitory computer-readable storage medium such as a memory 124, e.g., a combination of volatile memory elements (e.g., random access memory (RAM)) and non-volatile memory elements (e.g., flash memory or the like). The memory 124 stores a plurality of computer-readable instructions in the form of applications, including in the illustrated example a self-scanning application 128, whose execution by the processor 120 configures the device 108 to identify items in the cart 104, generate a list of the items, initiate payment transactions, and the like. As discussed below, execution of the application 128 also configures the processor 120 to perform various actions associated with the detection and handling of unscanned items in the cart 104.

The device 108 also includes a communications interface 132, enabling the device 108 to establish connections with networks deployed and/or accessible in the facility, and with the server 112 and/or the client device 116 (e.g., via such networks). The communications interface 132 can therefore include any suitable combination of transceivers, antenna elements, and corresponding control hardware enabling communications with such networks (or, in some examples, peer-to-peer communications that are not reliant on network infrastructure). In some examples, the functionality implemented by the application 128 can be implemented as two or more distinct applications, and/or in hardware, e.g., in the form of an application-specific integrated circuit (ASIC) or the like.

The device 108 can also include input and output devices such as a touch screen 136, e.g., including a display panel integrated with a touch panel. The device 108 can include other output devices such as a speaker 140, and can also include other input devices such as a microphone or the like.

The device 108 includes a data capture device, such as a camera 144, controllable (e.g., by the processor 120) to capture a sequence of images (e.g., a video stream) depicting at least a portion of an interior of the cart 104. The camera 144 can be positioned on the device 108 such that a field of view 148 of the camera 144 is aimed towards the interior of the cart 104. The device 108 can include additional data capture devices in other examples, such as a barcode scanner 152, such as a laser-based scanner, an image sensor, or the like. The scanner 152 can have a field of view that substantially coincides with the field of view 148, or a field of view distinct from (e.g., substantially non-overlapping with) the field of view 148. In some examples, the scanner 152 can be omitted, and images captured via the camera 144 can be processed for item identification (e.g., to detect and decode barcodes). In some examples, the device 108 also includes a printer 156, e.g., a direct thermal printer configured to print receipts or other transaction summaries upon completion of a transaction.

The server 112 includes a processor 160, such as a CPU, GPU, or the like, communicatively coupled with a non-transitory computer-readable storage medium such as a memory 164, e.g., a combination of volatile and non-volatile memory elements. The memory 164 stores one or more applications executable by the processor 160, including an anomaly tracking application 168. Execution of the application 168 by the processor 160 configures the server 112 to receive and store the anomaly data mentioned above, e.g., in a repository 172, and to retrieve transmit at least certain portions of the anomaly data to the client device 116. The server 112 also includes a communications interface 176, e.g., enabling the server 112 to communicate with either or both of the device 108 and the client device 116.

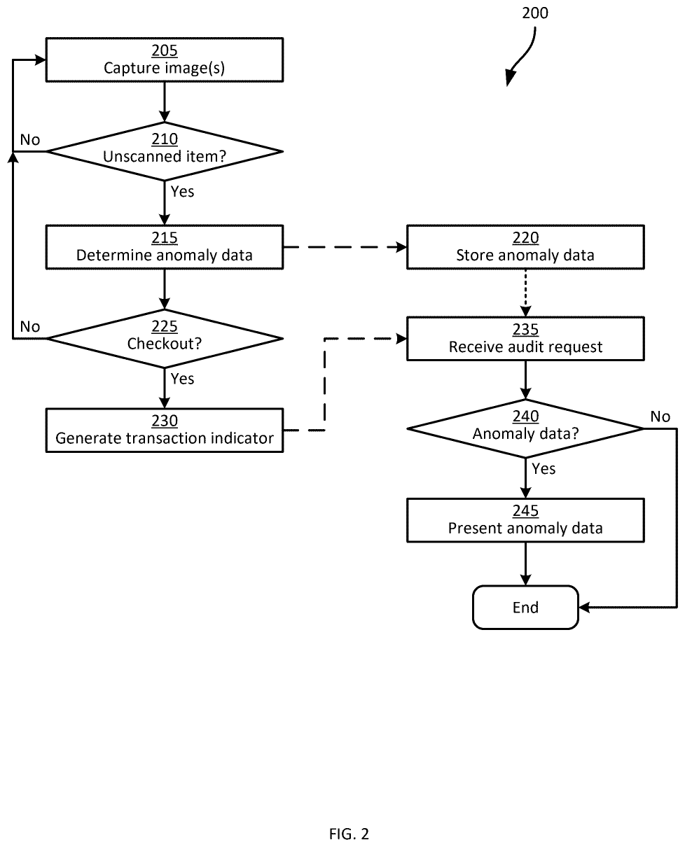

Turning to FIG. 2, a method 200 of handling unscanned items is illustrated. The method 200 is described below in conjunction with its performance within the system 100. Certain blocks of the method 200 are performed by the device 108 via execution of the application 128 by the processor 120. Other blocks of the method 200 can be performed by the device 108 in some implementations, or by the server 112 via execution of the application 168 by the processor 160 in other implementations, as indicated below.

The device 108 can be configured to begin performance of the method 200 in response to an input from the customer indicating the start of a self-scanning session. At block 205, the device 108 is configured to capture one or more images of an interior of the cart 104, e.g., the portion of the cart 104 that falls within the field of view 148 shown in FIG. 1. The device 108 can, for example, begin capturing a video stream (e.g., at a frame rate of ten frames per second, although higher and lower frame rates can also be employed, based on the computational resources available to the device 108) when a self-scanning session begins. Each frame of the video stream can be processed as described below, in some examples. In other examples, the device 108 can be configured to capture individual images, e.g., once every five seconds, or according to any other configured period.

At block 210, the device 108 is configured to determine whether the image from block 205, e.g., the most recently-captured frame in a video stream, contains an unscanned item. To perform the determination at block 210, the device 108 is configured to detect objects in the captured images, and to determine whether any detected object is “new” (that is, whether the object was not detected in a previous image). Detection of objects can be performed by the device 108 by performing any suitable object-detection operation, e.g., You Only Look Once (YOLO) or the like. An object detection operation may yield, for example, a bounding box surrounding each detected item. The device 108 can be configured to track detected objects between frames, and can therefore determine which objects, if any, of those detected in a given frame are newly detected objects.

The nature of the determination of whether the cart 104 contains an unscanned item can vary based on the mechanism by which the device 108 is configured to identify items. For example, in implementations involving explicit scanning of items (e.g., in which the customer holds an item in the field of view of the scanner 152 before placing the item in the cart 104), the device 108 can determine whether scan data was received before detection of the item, and after the immediately preceding object detection. In implementations where the device 108 is configured to identify items without explicit scanning, e.g., by performing object classification, barcode detection, or the like, on the above-mentioned bounding box corresponding to a newly detected item, the device 108 can be configured to determine that the item is “unscanned” when such item-identification mechanisms fail (e.g., produce an identification result with an insufficient confidence level, or the like).

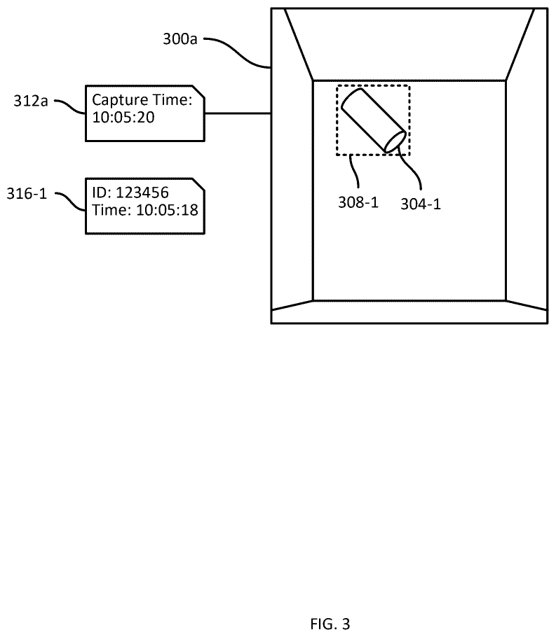

Turning to FIG. 3, an example image 300a captured at a first performance of block 205 is shown. The image 300a shows an interior of the cart 104, in which an item 304-1 has been detected. For example, the device 108 can generate a bounding box 308-1 indicating a position of the item 304-1 within the image 300a. The image 300a can be associated with metadata 312a, such as a timestamp indicating when the image 300a was captured. The device 108 can determine whether the item 304-1 is an unscanned item by comparing the above-mentioned timestamp to a most recently-obtained scan result 316-1, e.g., containing a timestamp and an item identifier “123456”. The scan result 316-1 was captured before the image 300a (e.g., within a threshold time period of the image's capture), and no other newly placed items were detected between the scan result and the image capture. The determination at block 210 is therefore negative.

When the determination at block 210 is negative, the device 108 can return to block 205 to process the next image. The device 108 can also, for example, store the item identifier in a list for the self-scanning session, and can retrieve price data from the server 112 or from local memory for the item identifier. The price data can be added to the list, e.g., for use in completing payment at the end of the self-scan session.

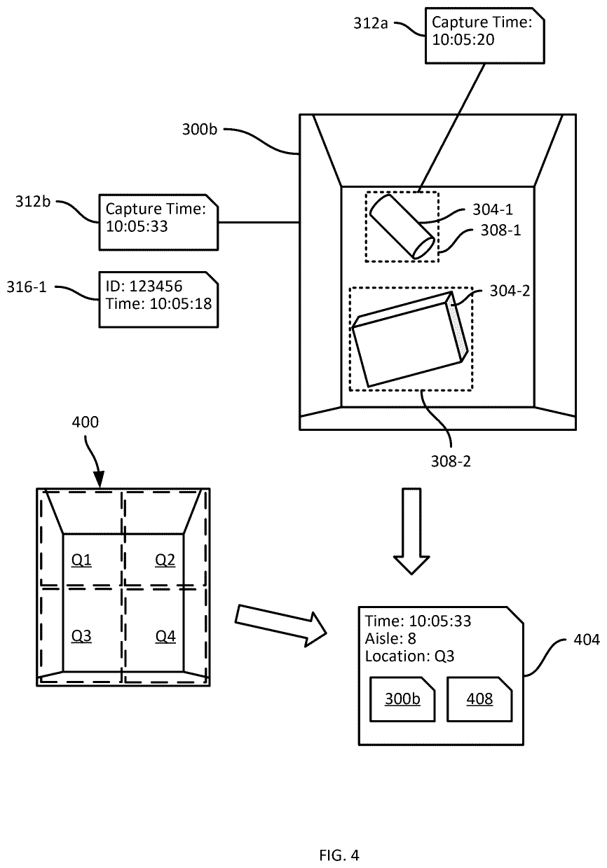

FIG. 4 illustrates another image 300b, captured after the image 300a, as indicated in the metadata 312b. As shown in the image 300b, the item 304-1 is still present, and a new item 304-2 has been placed in the cart 104. The device 108 has detected the item 304-2, as indicated by the bounding box 308-2. The most recent scan result is the scan result 316-1, indicating that no further scan result has been obtained since the image 300a was captured. In other words, the device 108 has not obtained a scan result associated with the item 304-2. The determination at block 210 is therefore affirmative.

Returning to FIG. 2, following an affirmative determination at block 210, the device 108 determines anomaly data at block 215. The anomaly data is deployed (e.g., stored locally at the device 108 and/or transmitted to the server 112 for storage in the repository 172) for subsequent retrieval, e.g., to accelerate an audit of the contents of the cart 104 after the self-scan session is complete.

The anomaly data includes one or more files, values, or the like, selected to provide guidance to the unscanned item 304-2 within the cart 104, even after further items have 304 been placed in the cart 104, potentially obscuring the item 304-2, and lengthening the list of items associated with the self-scan session. As will be apparent, the longer the list of items associated with the self-scan session, e.g., as presented on a receipt following completion of the self-scan session, the more time may be involved in comparing the contents of the cart 104 to the receipt to determine which item(s) 304 were not scanned.

The anomaly data therefore includes, in the present example, a location of the item 304-2 within the cart 104. The device 108 can determine the location of the item 304-2 within the cart 104 based on the position of the camera 144 relative to the cart 104. For example, the device 108 can store calibration data defining a transformation between pixel coordinates of the images captured by the camera 144, and a coordinate system defined relative to the cart 104 (e.g., having an origin at a corner of the cart's interior). In some examples, pixel coordinates from the image, e.g., corresponding to the bounding box 308-2, can be used as the location for the anomaly data.

In other examples, as shown in FIG. 4, the location determined at block 215 includes an identifier of a quadrant of the cart 104 in which the item 304-2 is present. For example, the device 108 can store a mapping 400 between the pixel coordinates of the camera 144 and quadrants or other regions of the cart 104. The device 108 can select, as a location for the unscanned item 304-2, the quadrant containing the largest portion of the item 304-2 (e.g., the quadrant “Q3” in this example.

Example anomaly data 404 is shown in FIG. 4, including the location (in the form of a quadrant identifier, in this example). The anomaly data 404 can also include the time the item 304-2 was detected (e.g., 10:05:33 in this example, corresponding to the time the image 300b was captured). The anomaly data 404 can further include the image 300b, as well as the coordinates of the bounding box 308-2. In some examples, the anomaly data 404 can also include an additional set of images 408. The additional images 408 are images in the sequence initiated at block 205 that precede the image 300b. For example, the device 108 can be configured to select a predetermined number of frames preceding the image 300b in the sequence, which form a video. For example, the video included in the anomaly data 404 may have a length of less than about five seconds, although in some examples longer sections of video can be included in the anomaly data, up to and including the entire sequence of images. In such examples, the video can include one or more bookmarks or other indicators of temporal positions in the video where unscanned item(s) appear. The additional images 408 therefore depict the placement of the item 304-2 into the cart 104.

The anomaly data 404 can also include a location of the cart 104 in the facility, such as an aisle identifier. The location can be determined via wireless beacons (e.g., Bluetooth low-energy beacons or the like) disposed at each entrance to each aisle, each transmitting beacons containing the identifier of the corresponding aisle. A wide variety of other locationing techniques can also be implemented by the device 108, however, including techniques based on triangulation relative to wireless base stations (e.g., access points of a wireless local area network in the facility), techniques based on images and/or motion sensor data (e.g., an additional camera and an inertial measurement unit or IMU), such as those implemented in the ARCore software development kit, and the like.

Referring again to FIG. 2, having determined the anomaly data 404 at block 215, the device 108 is configured to deploy the anomaly data 404 for subsequent retrieval, e.g., by the client device 116. Deploying the anomaly data 404 can include either or both of storing the anomaly data 404 in the memory 124, and transmitting the anomaly data 404 to the server 112 for storage in the repository 172. When the anomaly data 404 is transmitted to the server 112, the anomaly data 404 can include, or be transmitted along with, a transaction identifier corresponding to the self-scan session. The transaction identifier can enable the server 112 to subsequently retrieve anomaly data associated with a particular self-scan session, as the server 112 may receive anomaly data from a plurality of carts 104. The transaction identifier can include an alphanumeric string, for example, generated at the cart 104.

The device 108 and/or the server 112 can therefore store the anomaly data at block 220. Following deployment of the anomaly data 404, the device 108 is configured to determine, at block 225, whether to end the self-scan session and initiate a payment process, e.g., whether to perform a self-checkout operation. The device 108 can make the determination at block 225 based on whether an input has been received (e.g., at the touch screen 136) from the customer selecting a checkout option presented on the touch screen 136. When the determination at block 225 is negative, the device 108 can return to block 205. When the determination at block 225 is affirmative, the device 108 proceeds to block 230.

In some examples, following the receipt of the anomaly data 404 at block 220, the server 112 can be configured to generate and send one or more notifications via the communications interface 176. For example, the device 108 can send a notification to the server 112, for delivery to the client device 116. The operator of the client device 116 may, for example, proceed to the aisle indicated in the anomaly data 404 to resolve the unscanned item. If the unscanned item 304-1 is identified and added to the transaction list by the device 108 in response to intervention by a staff member (e.g., the operator of the client device 116), the client device 116 can transmit a command to either or both of the server 112 and the device 108 to discard the anomaly data 404.

At block 230, the device 108 can generate a transaction indicator, e.g., along with initiating a payment process for the customer to pay for the items identified during the self-scanning session and added to the list mentioned earlier. The transaction indicator can include a physical receipt, e.g., generated via the printer 156. In other cases, the transaction indicator can include an email or other data exchange, e.g., transmitted to a computing device of the customer such as a smartphone or the like. The transaction indicator includes, among other data, the previously mentioned transaction identifier, e.g., printed on the receipt. The transaction identifier can be encoded in a barcode or other machine-readable indicium appearing on the receipt.

Upon completion of the self-scan session and the payment process mentioned above, the customer may proceed towards an exit of the facility. A staff member of the facility may conduct audits of exiting carts 104 at or near the exit. The staff member may operate the client device 116 (as will be apparent, there may be a plurality of client devices 116 deployed in the facility).

The client device 116 can transmit an audit request to the server 112, or directly to the device 108. For example, the device 116 can scan the receipt, or otherwise obtain the transaction identifier from the transaction indicator generated by the device 108 at block 230. The device 116 can send a request to the server 112, for example, including the transaction identifier. At block 235, the server 112 is configured to receive the audit request. At block 240, in response to receiving the audit request, the server 112 is configured to determine whether the repository 172 contains any anomaly data associated with the transaction identifier in the audit request. In examples where the device 108 performs blocks 235 and 240, the client device 116 can send the audit request directly to the device 108, and the device 108 can determine whether any anomaly data is stored in the memory 124 associated with the transaction identifier in the audit request.

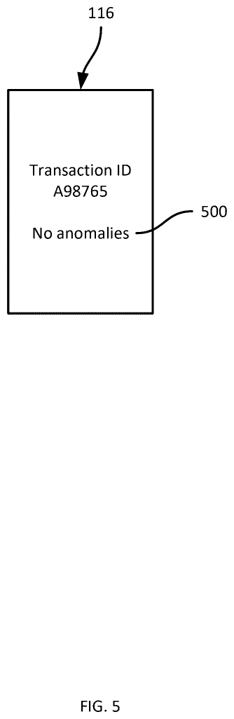

When the determination at block 240 is negative, indicating that the server 112 did not receive any anomaly data in association with the requested transaction identifier, the server 112 can return a message indicating that no anomalies were detected, and performance of the method 200 can end. For example, the device 116 can present a notification 500, as shown in FIG. 5, that no anomalies were detected during the self-scan session for the requested transaction identifier. The operator of the device 116 may, in other words, dispense with a manual comparison of the receipt with the contents of the cart 104, significantly reducing the time consumed by the audit.

When the determination at block 240 is affirmative, the server 112 can be configured to retrieve the anomaly data 404 (and any other anomaly data detected during blocks 205-215 for the requested transaction request) and transmit the anomaly data 404 to the device 116 for presentation, e.g., on a display of the client device 116. In examples where the device 108 receives the audit request at block 235, the device 108 can retrieve the anomaly data 404 from the memory 124 and transmit the anomaly data 404 to the device 116 for presentation. In some examples, the device 108 can present the anomaly data on the touch screen 136.

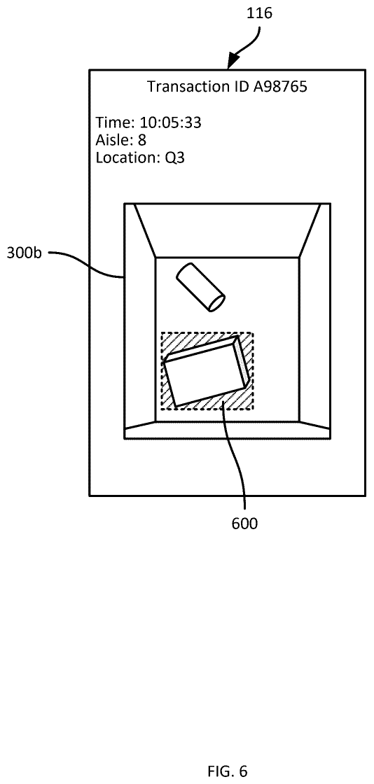

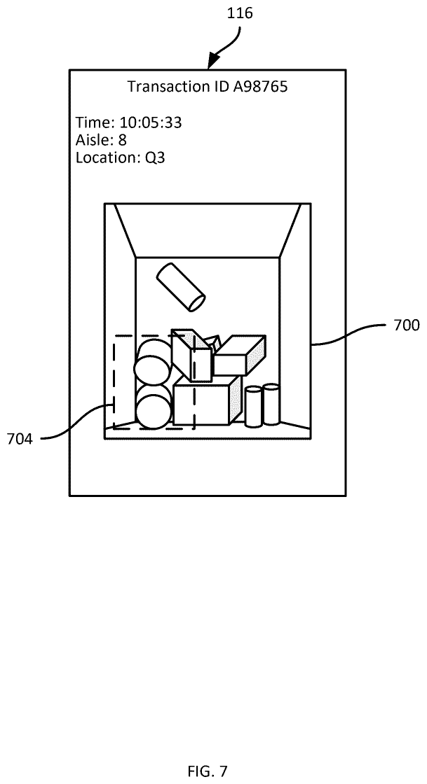

FIG. 6 illustrates an example performance of block 245. In the illustrated example, the device 116 displays the image 300b, e.g., along with an overlay 600 corresponding to the bounding box 308-2. In other examples, the device 108 can present a reference image of the cart 104 (e.g., an image of an empty cart 104), with the overlay 600. FIG. 7 illustrates a further example performance of block 245, in which the device 116 presents a current view 700 of the cart 104 (e.g., via a camera of the device 116). As seen in FIG. 7, the item 304-1 is not visible. The device 116 can also present an overlay 704, e.g., corresponding to the quadrant identified in the anomaly data 404. The device 116 can be configured to determine a position of the device 116 relative to the cart in order to place the overlay 704, e.g., via a pose-tracking mechanism such as ARCore or the like. In other examples, the device 116 can display a video included in the anomaly data 404.

The device 116 can receive an input, e.g., from the operator thereof, indicating that the anomaly has been resolved, e.g., when the item 304-1 has been located and paid for or removed from the cart 104. The device 116 can notify the server 112 and/or the device 108 that the anomaly has been resolved, and in response the server 112 and/or the device 108 can discard the anomaly data 404.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
detecting an unscanned item within a cart from an image of an interior of the cart;
in response to detecting the unscanned item, determining a location of the unscanned item within the cart;
generating anomaly data having the location of the unscanned item within the cart; and
causing a display of the anomaly data.

2. The method of claim 1, wherein determining the location of the unscanned item within the cart includes determining, based on a position of the unscanned item within the image, one of a set of predefined portions of the cart containing the unscanned item.

3. The method of claim 1, wherein causing the display of the anomaly data includes storing the anomaly data in a memory.

4. The method of claim 1, wherein causing the display of the anomaly data includes transmitting the anomaly data to a server via a communications interface.

5. The method of claim 1, further comprising: determining a location of the cart in a facility;
wherein the anomaly data includes the location of the cart.

6. The method of claim 1, wherein the anomaly data further comprises the image.

7. The method of claim 1, further comprising:
in response to detecting the unscanned item, selecting a plurality of images preceding the image in a sequence;
wherein the anomaly data includes the image and the selected plurality of the images.

8. The method of claim 1, further comprising:
associating a transaction indicator with the anomaly data; and
outputting the transaction indicator.

9. The method of claim 8, further comprising:
receiving an audit request including the transaction indicator;
retrieving the anomaly data; and
providing the retrieved anomaly data for presentation on a display.

10. The method of claim 9, wherein providing the retrieved anomaly data includes:
controlling the display to present an image of the cart and an overlay including the anomaly data.

11. A computing device, comprising:
a processor configured to:
detect an unscanned item within a cart from an image of an interior of the cart;
in response to detecting the unscanned item, determine a location of the unscanned item within the cart;
generate anomaly data having the location of the unscanned item within the cart; and
cause a display of the anomaly data.

12. The computing device of claim 11, wherein the processor is configured to determine the location of the unscanned item within the cart by determining, based on a position of the unscanned item within the image, one of a set of predefined portions of the cart containing the unscanned item.

13. The computing device of claim 11, further comprising a memory; wherein the processor is configured to cause the display of the anomaly data by storing the anomaly data in the memory.

14. The computing device of claim 11, further comprising a communications interface; wherein the processor is configured to cause the display of the anomaly data by transmitting the anomaly data to a server via the communications interface.

15. The computing device of claim 11, wherein the processor is configured to:
determine a location of the cart in a facility; wherein the anomaly data includes the location of the cart.

16. The computing device of claim 11, wherein the anomaly data further comprises the image.

17. The computing device of claim 11, wherein the processor is configured to:
in response to detecting the unscanned item, select a plurality of images preceding the image in a sequence;
wherein the anomaly data includes the image and the selected plurality of the images.

18. The computing device of claim 11, wherein the processor is configured to:
associate a transaction indicator with the anomaly data; and
output the transaction indicator.

19. The computing device of claim 18, wherein the processor is configured to:
receive an audit request including the transaction indicator;
retrieve the anomaly data; and
provide the retrieved anomaly data for presentation on a display.

20. The computing device of claim 19, wherein the processor is configured to provide the retrieved anomaly data by:
controlling the display to present an image of the cart and an overlay including the anomaly data.
